(19) United States
(12) Patent Application Publication
(10) Pub. No.: US 2021/0382198 A1
(43) Pub. Date: Dec. 9, 2021

(54) UNCERTAINTY-AWARE MODELING AND DECISION MAKING FOR GEOMECHANICS WORKFLOW USING MACHINE LEARNING APPROACHES

(71) Applicant: Chevron U.S.A. Inc., San Ramon, CA (US)

(72) Inventors: Shuxing Cheng, Katy, TX (US); Peng L. Ray, Spring, TX (US)

(21) Appl. No.: 16/892,050

(22) Filed: Jun. 3, 2020

(51) Int. Cl. G01V 99/00; G06F 30/20; G06F 30/17; G06N 7/00

(52) U.S. Cl. CPC G01V 99/005; G06N 7/005; G06F 30/17; G06F 30/20

(57) ABSTRACT

A Gaussian process is used to provide a nonparametric approach for modeling nonlinear relationships among physical quantities involved in the geomechanics workflow supporting drilling & completion operations. Gaussian process provides a nonparametric framework that enables injection of a prior belief into the basic model format while allowing its specific format to be adaptive in a certain range following an estimated distribution. Both this model-related uncertainty and the pre-assumed input data distributions may be calibrated using non-parametric Bayesian framework with Gaussian process as prior. This approach not only the addresses the uncertainty stemming from the input physical properties but also tackles the uncertainties underlying the adopted physical model, all in this nonparametric Bayesian framework with Gaussian process encoded as prior.

### FIELD

The present disclosure relates generally to the field of geomechanical simulation of subsurface regions with uncertainty estimation.

### BACKGROUND

In context of geomechanics workflow to support drilling and completion operations, core test data may be available through in-house experiment and different types of log data collected across drilling and completion project lifecycle. Along with the availability of these diverse types of data sets, physics models may be used to perform mechanics analysis, such as wellbore analysis. With respect to this workflow, the output may be impacted by uncertainties, such as model inadequacy, measurement error, and incorrect assumption on the input data distributions. These uncertainty factors may be classified into two categories: epistemic uncertainty and aleatory uncertainty, where the former one can be reduced by collecting more data or accumulate more knowledge over the studied system and the latter one are usually treated as inherent randomness which is unavoidable. The existing deterministic geomechanics workflow fails to capture such uncertainties and only make point estimation. From the decision making perspective, it is necessary to extend the point estimation into a quantitative range prediction with uncertainty factors being incorporated.

### SUMMARY

This disclosure relates to supporting geomechanical simulation of subsurface regions with uncertainty estimation. Physical quantity information for a subsurface region may be obtained. The physical quantity information may characterize physical quantities of the subsurface region. The physical quantities may include base physical quantities and derived physical quantities. Nonlinear relationships may exist between the base physical quantities and the derived physical quantities. A probabilistic model that captures the nonlinear relationships between the base physical quantities and the derived physical quantities of the subsurface region may be constructed. The probabilistic model may receive input base physical quantities and output predicted derived physical quantities with prediction intervals. Observed information for the subsurface region may be obtained. The observed information may characterize observed physical attributes of the subsurface region. The observed physical attributes may enable verification of the predicted derived physical quantities outputted by the probabilistic model. The probabilistic model may be calibrated based on the observed physical attributes of the subsurface region and/or other information.

A system that supports geomechanical simulation of subsurface regions with uncertainty estimation may include one or more electronic storage, one or more processors and/or other components. The electronic storage may store physical quantity information, information relating to physical quantities, information relating to base physical quantities, information relating to derived physical quantities, information relating to nonlinear relationships between base physical quantities and derived physical quantities, information relating to subsurface region, information relating to probabilistic model, observed information, information relating to observed physical attributes, information relating to calibration of probabilistic model, and/or other information.

The processor(s) may be configured by machine-readable instructions. Executing the machine-readable instructions may cause the processor(s) to facilitate supporting geomechanical simulation of subsurface regions with uncertainty estimation. The machine-readable instructions may include one or more computer program components. The computer program components may include one or more of a physical quantity information component, a probabilistic model component, an observed information component, a calibration component, and/or other computer program components.

The physical quantity information component may be configured to obtain physical quantity information for a subsurface region and/or other information. The physical quantity information may characterize physical quantities of the subsurface region. The physical quantities may include base physical quantities, derived physical quantities, and/or other physical quantities. Nonlinear relationships may exist between the base physical quantities and the derived physical quantities.

The probabilistic model component may be configured to construct a probabilistic model that captures the nonlinear relationships between the base physical quantities and the derived physical quantities of the subsurface region. The probabilistic model may receive input base physical quantities and output predicted derived physical quantities with prediction intervals. In some implementations, predicted physical attributes of the subsurface region may be determined based on the predicted derived physical quantities, and/or other information.

The observed information component may be configured to obtain observed information for the subsurface region, and/or other information. The observed information may characterize observed physical attributes of the subsurface region. The observed physical attributes may enable verification of the predicted derived physical quantities outputted by the probabilistic model.

The calibration component may be configured to calibrate the probabilistic model. The probabilistic model may be calibrated based on the observed physical attributes of the subsurface region, and/or other information. In some implementations, the probabilistic model may be calibrated using a Bayesian framework. In some implementations, the Bayesian framework may be used to calibrate a geomechanical model for the subsurface region.

In some implementations, calibration of the probabilistic model using the Bayesian framework may include updating prior belief of the base physical quantities and the derived physical quantities for the subsurface region using the observed physical attributes of the subsurface region based on a posterior analysis in the Bayesian framework. The probabilistic model along with the Bayesian framework may be used to refine the prior belief over the base physical quantities and the derived physical quantities of the subsurface region.

In some implementations, calibration of the probabilistic model using the Bayesian framework may include updating functions modeled by the probabilistic model to capture the nonlinear relationships between the base physical quantities and the derived physical quantities of the subsurface region.

In some implementations, the subsurface region may include one or more wellbores, and the probabilistic model along with the Bayesian framework provides a probabilistic-driven stability analysis of the wellbore(s).

The probabilistic-driven stability analysis of the wellbore may include analysis of sanding risk. The probabilistic-driven stability analysis of the wellbore may be used for drilling of the wellbore, completion of the wellbore, and/or production using the wellbore. The probabilistic-driven stability analysis of the wellbore may enable a risk-based decision making process.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates an example system that supports geomechanical simulation of subsurface regions with uncertainty estimation.

FIG. 2 illustrates an example method for supporting geomechanical simulation of subsurface regions with uncertainty estimation.

FIG. 3 illustrates an example workflow for supporting geomechanical simulation of subsurface regions with uncertainty estimation.

FIG. 4 illustrates example input and output of a probabilistic model.

FIG. 5 illustrates an example workflow for calibrating a probabilistic model using Bayesian framework.

FIG. 6 illustrates an example workflow for calibrating a geomechanical model using Bayesian framework.

FIG. 7 illustrates an example workflow for calibrating a physics model using Bayesian framework.

### DETAILED DESCRIPTION

The present disclosure relates to supporting geomechanical simulation of subsurface regions with uncertainty estimation. A Gaussian process is used to provide a nonparametric approach for modeling nonlinear relationships among physical quantities involved in the geomechanics workflow supporting drilling & completion operations. Gaussian process provides a nonparametric framework that enables injection of a prior belief into the basic model format while allowing its specific format to be adaptive in a certain range following an estimated distribution. Both this model-related uncertainty and the pre-assumed input data distributions may be calibrated using non-parametric Bayesian framework with Gaussian process as prior. This approach not only addresses the uncertainty stemming from the input physical properties but also tackles the uncertainties underlying the adopted physical model, all in this nonparametric Bayesian framework with Gaussian process encoded as prior.

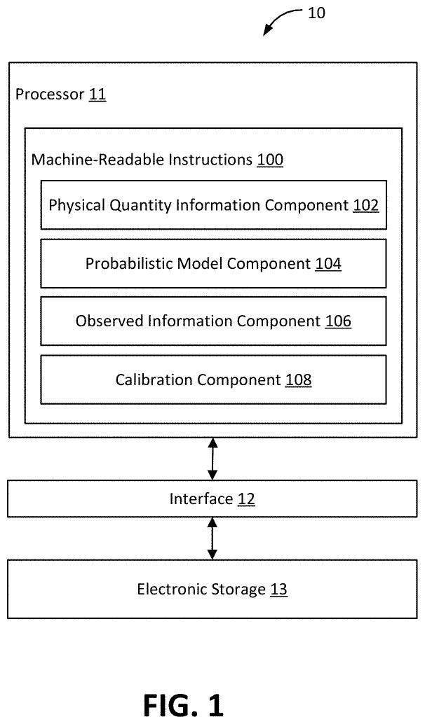

The methods and systems of the present disclosure may be implemented by and/or in a computing system, such as a system 10 shown in FIG. 1. The system 10 may include one or more of a processor 11, an interface 12 (e.g., bus, wireless interface), an electronic storage 13, and/or other components. Physical quantity information for a subsurface region may be obtained by the processor 11. The physical quantity information may characterize physical quantities of the subsurface region. The physical quantities may include base physical quantities and derived physical quantities. Nonlinear relationships may exist between the base physical quantities and the derived physical quantities. A probabilistic model that captures the nonlinear relationships between the base physical quantities and the derived physical quantities of the subsurface region may be constructed by the processor 11. The probabilistic model may receive input base physical quantities and output predicted derived physical quantities with prediction intervals. Observed information for the subsurface region may be obtained by the processor 11. The observed information may characterize observed physical attributes of the subsurface region. The observed physical attributes may enable verification of the predicted derived physical quantities outputted by the probabilistic model. The probabilistic model may be calibrated by the processor 11 based on the observed physical attributes of the subsurface region and/or other information.

Essential elements in decision-making process of drilling and completion include wellbore stability analysis and sanding risk modeling. Deterministic workflows for wellbore stability analysis and sanding risk modeling fail to capture aleatory uncertainty and epistemic uncertainty arising from factors such as spatial variability, random testing errors, incomplete geomechanical models, measurement procedures and limited data availability, which makes the decision-making process inherently unreliable.

The present disclosure provides a framework that incorporates uncertainty analysis as the underlying modeling philosophy. The framework enables incorporation of domain knowledge as prior belief for models and parameter distribution, calibration of the prior belief using new observations, and making predictions based on the calibrated models. The framework provides a continuous approach that improves asset development planning and execution through development life cycles. The framework enables decision-making process for drilling and completion in a rigorous probabilistic framework, which facilitates systematic uncertainty analysis with quantitative metrics instead of qualitative evaluations. The framework also enables combination of geomechanical model and field observations for an adaptive decision-making process. The framework also performs as a global workflow, which provides flexibility to allow modifiable process branches that are tailored to localized conditions.

Bayesian machine learning is used as the modeling foundation for building the uncertainty analysis framework. Bayesian nonparametric approach for modeling highly nonlinear relationships (e.g., Gaussian process) may be used to construct a probabilistic model. Bayesian machine learning enables encoding of prior beliefs about models, model parameters, and data generation processes. Posterior analysis performed using Bayesian framework enables comparison of different models, calibration of model stings, and calculation of prediction interval (e.g., P10, P50, P90 values). The prediction interval may provide a direct metric for evaluating uncertainty resulting from data and/or the model.

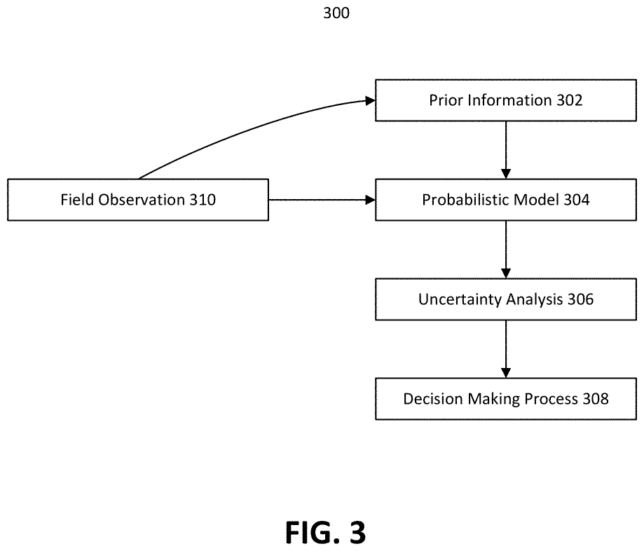

FIG. 3 illustrates an example workflow 300 for supporting geomechanical simulation of subsurface regions with uncertainty estimation. The workflow 300 may utilize a Bayesian framework to train and calibrate a probabilistic model 304. In the workflow 300, prior information 302 on geomechanical systems may be used to construct the probabilistic model 304. The prior information 302 may include prior beliefs regarding the geomechanical systems, such as base physical quantities and derived physical quantities for a subsurface region. The base physical quantities and derived physical quantities may form input-output pairs in constructing the probabilistic model 304. Nonlinear relationships may exist between the base physical quantities and the derived physical quantities.

The probabilistic model 304 may be constructed using Bayesian machine learning, such as by training a Gaussian process model as a Bayesian nonparametric approach. The probabilistic model 304 may capture the nonlinear relationships between the base physical quantities and the derived physical quantities. The probabilistic model 304 may capture the nonlinear relationships between the base physical quantities and the derived physical quantities with minimal assumptions on the potential model shapes, which may naturally be given via its nonparametric model paradigm. The probabilistic model 304 may be used as a surrogate for a geomechanical model for the region. Compared to deterministic geomechanical models that provide only point estimation, the probabilistic model 304 may provide prediction as well. The probabilistic model 304 may, for an input, provide an output with prediction interval of the output. The combination of the output with the prediction interval may be used for uncertainty analysis 306. The uncertainty analysis 306 may be used to evaluate risk factors for well operations, such as drilling operations, completion operations, production operations, and/or other well operations. Decision making process 308 for well operations may incorporate the uncertainty analysis 306, as well as other factors relating to well operations (e.g., economics, deadlines).

The probabilistic model 304 may be updated (calibrated) using field observation 310. The field observation 310 may include collection of field data. The field data may be used to verify outputs of the probabilistic model 304. The field data may be used to compute the probability distribution of the prior information 302 (e.g., compute posterior distribution). The field data may be used to calibrate the probabilistic model 304, which may result in more accurate results being output by the probabilistic model 304. The field data may also be used to refine knowledge on the prior information 302, which may be represented as a probability distribution for the input. Insights on the region obtained through the workflow 300 may be used to help make better decisions on well operations, as well as make better decisions on data collection and other operations relating to wells in the region. The workflow 300 may provide an iterative process for improving model and uncertainty for well operations.

Referring back to FIG. 1, The electronic storage 13 may be configured to include electronic storage medium that electronically stores information. The electronic storage 13 may store software algorithms, information determined by the processor 11, information received remotely, and/or other information that enables the system 10 to function properly. For example, the electronic storage 13 may store physical quantity information, information relating to physical quantities, information relating to base physical quantities, information relating to derived physical quantities, information relating to nonlinear relationships between base physical quantities and derived physical quantities, information relating to subsurface region, information relating to probabilistic model, observed information, information relating to observed physical attributes, information relating to calibration of probabilistic model, and/or other information.

The processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate supporting geomechanical simulation of subsurface regions with uncertainty estimation. The machine-readable instructions 100 may include one or more computer program components. The machine-readable instructions 100 may include one or more of a physical quantity information component 102, a probabilistic model component 104, an observed information component 106, a calibration component 108, and/or other computer program components.

The physical quantity information component 102 may be configured to obtain physical quantity information for a subsurface region and/or other information. Obtaining physical quantity information may include one or more of accessing, acquiring, analyzing, creating, determining, examining, generating, identifying, loading, locating, opening, receiving, retrieving, reviewing, selecting, storing, utilizing, and/or otherwise obtaining the physical quantity information. The physical quantity information component 102 may obtain physical quantity information from one or more locations. For example, the physical quantity information component 102 may obtain physical quantity information from a storage location, such as the electronic storage 13, electronic storage of a device accessible via a network, and/or other locations. The physical quantity information component 102 may obtain physical quantity information from one or more hardware components (e.g., a computing device, a component of a computing device) and/or one or more software components (e.g., software running on a computing device). Physical quantity information may be stored within a single file or multiple files.

The physical quantity information may characterize physical quantities of a subsurface region. The physical quantity information may characterize physical quantities of a subsurface region by including information that describes, delineates, identifies, is associated with, quantifies, reflects, sets forth, and/or otherwise characterizes the physical quantities of the subsurface region. For example, the physical quantity information may characterize physical quantities of a subsurface region by including information that specifies the physical quantities at different locations in the subsurface region and/or information that is used to determine the physical quantities at different locations in the subsurface region. The physical quantity information may characterize physical quantities of a subsurface region at one or more moments in times. A moment in time may include a point in time or a duration of time. For example, the physical quantity information may characterize physical quantities of a subsurface region at a particular moment in time and/or at different moments in time. Other types of physical quantity information are contemplated.

A subsurface region may refer to a part of earth located beneath the surface/located underground. A subsurface region may refer to a part of earth that is not exposed at the surface of the ground. A subsurface region may be defined in a single dimension (e.g., a point, a line) or in multiple dimensions (e.g., a surface, a volume). A subsurface region may include one or more wells. A well may refer to a hole or a tunnel in the ground. A well may be drilled in one or more directions. For example, a well may include a vertical well, a horizontal well, a deviated well, and/or other type of well. A well may be drilled in the ground for exploration and/or recovery of natural resources in the ground. For example, a well may be drilled in the ground to aid in extraction/production of hydrocarbons. As another example, a well may be drilled in the ground for fluid injection. Application of the present disclosure to other types of wells and wells drilled for other purposes are contemplated.

A well may be drilled into a subsurface region using practically any drilling technique and equipment known in the art, such as geosteering, directional drilling, etc. Drilling a wellbore may include using a tool, such as a drilling tool that includes a drill bit and a drill string. Drilling fluid, such as drilling mud, may be used while drilling in order to cool the drill tool and remove cuttings. Other tools may also be used while drilling or after drilling, such as measurement-while-drilling (MWD) tools, seismic-while-drilling (SWD) tools, wireline tools, logging-while-drilling (LWD) tools, or other downhole tools. After drilling to a predetermined depth, the drill string and the drill bit may be removed, and then the casing, the tubing, and/or other equipment may be installed according to the design of the well. The equipment to be used in drilling a well may be dependent on the design of the well, the subsurface region, the hydrocarbons, and/or other factors.

A well may include a plurality of components, such as, but not limited to, a casing, a liner, a tubing string, a heating element, a sensor, a packer, a screen, a gravel pack, artificial lift equipment (e.g., an electric submersible pump (ESP)), tubing, and/or other components. If a wellbore is drilled offshore, the wellbore may include one or more of the previous components plus other offshore components, such as a riser. A wellbore may also include equipment to control fluid flow into the wellbore, control fluid flow out of the wellbore, or any combination thereof. For example, a well may include a wellhead, a blowout preventer (BOP), a choke, a valve, or other control devices. These control devices may be located on the surface, under the surface (e.g., downhole in the well), or any combination thereof. In some embodiments, same control devices may be used to control fluid flow into and out of a well. In some embodiments, different control devices may be used to control fluid flow into and out of a well. In some embodiments, the rate of flow of fluids through a well may depend on the fluid handling capacities of the surface facility that is in fluidic communication with the well. The equipment to be used in controlling fluid flow into and out of a well may be dependent on the well, the subsurface region, the surface facility, and/or other factors. Moreover, sand control equipment and/or sand monitoring equipment may also be installed (e.g., downhole and/or on the surface). A well may also include any completion hardware that is not discussed separately. The term “wellbore” may be used synonymously with the terms “borehole,” “well,” or “well bore.” The term “well” or “wellbore” is not limited to any description or configuration described herein.

Physical quantities of a subsurface region may refer to properties of the subsurface region that may be quantified by measurement. Properties of a subsurface region may refer to attribute, quality, and/or characteristics of the subsurface region. Properties of a subsurface region may refer to physical arrangement of materials (e.g., subsurface elements) within the subsurface region, type of materials within the subsurface region, characteristics of materials within the subsurface region, composition of materials within the subsurface region, and/or other properties of the subsurface region. For example, physical quantities of a subsurface region may include values that characterize physical characteristics of the subsurface region.

Physical quantities may include base physical quantities (X), derived physical quantities (Y), and/or other physical quantities. Base physical quantities may refer to physical quantities that are distinct in nature. Base physical quantities may refer to physical quantities that are not defined in terms of other physical quantities. Base physical quantities may refer to physical quantities from which other physical quantities may be expressed. Examples of base physical quantities include velocities (e.g., vertical compression velocity, horizontal compression velocity, vertical shear velocity, horizontal shear velocity), density, porosity, mineralogy (e.g., Quartz, feldspar, calcite, dolomite, clay), and/or other base physical quantities.

Derived physical quantities may refer to physical quantities that are derived (computed, calculated, determined) from other physical quantities. For example, derived physical quantities may be derived from one or more base physical quantities, one or more other derived physical quantities, and/or other physical quantities. Examples of derived physical quantities include unconfined compressive strength, friction angle, vertical Young's module (Eᵥ), horizontal Young's modulus (Eₕ), vertical Poisson's ratio (vᵥ), horizontal Poisson's ratio (vₕ), and/or other derived physical quantities.

Physical attributes of the subsurface region may refer to physical quality and/or feature of the subsurface region that may be measured from field observation (field measurement data). For example, stress in the subsurface region may be measured from field observations. Physical attributes of the subsurface region may refer to physical quality and/or feature of the subsurface region that may be determined from the derived physical quantities of the subsurface region. For example, stress (e.g., horizontal stress, vertical stress) in the subsurface region may be measured from field observation and determined based on vertical Young's module (Eᵥ), horizontal Young's modulus (Eₕ), vertical Poisson's ratio (vᵥ), horizontal Poisson's ratio (vₕ), other derived physical quantities, and/or other information. Other types of physical attributes are contemplated.

In some implementations, physical quantities of a subsurface region may be determined based on one or more geotechnical core tests. For instance, a core of a well may be extracted and analyzed to determine the base physical quantities, the derived physical quantities, and/or other physical quantities of the well. For example, base physical quantities of the well may be observed through the geotechnical core test, and derived physical quantities of the well may be derived/calculated from the base physical quantities using correlation analysis.

Nonlinear relationships may exist between the base physical quantities and the derived physical quantities. While correlation analysis may be performed to determined derived physical quantities (Y) from base physical quantities (X), the correlation analysis may not fully capture the nonlinear relationships between the base physical quantities and the derived physical quantities. Functions and parameters to capture the nonlinear relationships between the base physical quantities and the derived physical quantities may be unknown. These nonlinear relationships may impact well operations, such as drilling and completion operations.

The probabilistic model component 104 may be configured to construct a probabilistic model for the subsurface region. The probabilistic model may be constructed by using the base physical quantities and the derived physical quantities of the subsurface region. The probabilistic model may be constructed by using as the base physical quantities and the corresponding derived physical quantities as input-output pairs. The probabilistic model may be constructed using one or more machine-learning technologies, such as Gaussian process, Bayesian neural network, and/or other machine learning technologies.

A probabilistic model may refer to a model that incorporates random variables and probability distributions into the model of the subsurface region. While a deterministic model may provide a single possible outcome for an event, a probabilistic model may provide a probability of distribution as a solution. The probabilistic model may not assume a fixed function to simulate the physics/geomechanics of the subsurface region. Rather, the probabilistic model may provide for a distribution of functions and a distribution of parameters to simulate the physics/geomechanics of the subsurface region.

The probabilistic model may be constructed by the probabilistic model component 104 to capture the nonlinear relationships between the base physical quantities (X) and the derived physical quantities (Y) of the subsurface region. The probabilistic model may model function and parameters to determine values of derived physical quantities based on values of base physical quantities (Y=f(X)), and provide prediction intervals for the determined values of derived physical quantities.

The probabilistic model may receive input base physical quantities (base physical quantities provided as input to the probabilities model) and output predicted derived physical quantities (derived physical quantities predicted by the probabilistic model based on the input base physical quantities) with prediction intervals. That is, the probabilistic model may receive as input values of base physical quantities and provide as output values of derived physical quantities. The probabilistic model may provide prediction intervals with the output values of derived physical quantities. The probabilistic model may provide prediction intervals for the predicted derived physical quantities by incorporating the uncertainty factors (e.g., uncertainty in subsurface measurement, uncertainty in model, uncertainty in function, uncertainty in parameters) underlying the physics/geomechanics of the subsurface region. The probabilistic model may enable geomechanical simulation of subsurface regions with uncertainty estimation. Compared to deterministic geomechanical models, the probabilities model may provide point estimation with prediction interval for individual estimation by incorporating the uncertainty factors underlying the physics/geomechanics of the subsurface region. The prediction interval may incorporate both measurement uncertainty and model uncertainty.

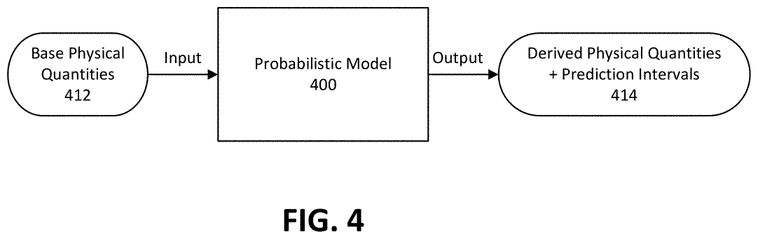

FIG. 4 illustrates example input and output of a probabilistic model 400. Input to the probabilistic model 400 may include base physical quantities 412 (values of base physical quantities of a subsurface region). Output of the probabilities model 400 may include derived physical quantities and prediction intervals 414 (values of derived physical quantities, along with prediction intervals for the values).

Predicted physical attributes of the subsurface region may be determined based on the predicted derived physical quantities, and/or other information. For example, stress in the subsurface region may be predicted based on predicted vertical Young's module (Eᵥ), predicted horizontal Young's modulus (Eₕ), predicted vertical Poisson's ratio (vᵥ), predicted horizontal Poisson's ratio (vₕ), other predicted derived physical quantities, and/or other information. It may not be possible to directly measure derived physical attributes of the subsurface region from field measurement. To verify the accuracy of derived physical quantities predicted by the probabilistic model, predicted physical attributes of the subsurface region may be determined from the predicted derived physical quantities, and the predicted physical attributes of the subsurface region may be compared with physical attributes of the subsurface region obtained from field measurement.

The observed information component 106 may be configured to obtain observed information for the subsurface region, and/or other information. Obtaining observed information may include one or more of accessing, acquiring, analyzing, creating, determining, examining, generating, identifying, loading, locating, opening, receiving, retrieving, reviewing, selecting, storing, utilizing, and/or otherwise obtaining the observed information. The observed information component 106 may obtain observed information from one or more locations. For example, the observed information component 106 may obtain observed information from a storage location, such as the electronic storage 13, electronic storage of a device accessible via a network, and/or other locations. The observed information component 106 may obtain observed information from one or more hardware components (e.g., a computing device, a component of a computing device) and/or one or more software components (e.g., software running on a computing device). Observed information may be stored within a single file or multiple files.

The observed information may characterize observed physical attributes of the subsurface region. The observed information may characterize observed physical quantities of a subsurface region by including information that describes, delineates, identifies, is associated with, quantifies, reflects, sets forth, and/or otherwise characterizes the observed physical quantities of the subsurface region. For example, the observed information may characterize observed physical quantities of a subsurface region by including information that specifies the observed physical quantities at different locations in the subsurface region and/or information that is used to determine the observed physical quantities at different locations in the subsurface region. The observed information may characterize observed physical quantities of a subsurface region at one or more moments in times. For example, the observed information may characterize observed physical quantities of a subsurface region at a particular moment in time and/or at different moments in time. Other types of observed information are contemplated.

Observed physical attributes of a subsurface region may refer to physical quality and/or feature of the subsurface region that is measured from field observation (field measurement data). Field observation may refer to measurements, tests, and/or other observations made at the region. Examples of field measurement data obtained from field observation include well logs, leak-off tests, diagnostic fracture injection testing (DFIT), seismic image log, mud loss, and/or other field measurement data. The observed physical attributes may enable verification of the predicted derived physical quantities outputted by the probabilistic model. For example, observed physical attributes of a subsurface region may include stress in the subsurface region, and the observed stress in the region may be used to verify predicted derived physical properties (predicted vertical Young's module (Eᵥ), predicted horizontal Young's modulus (Eₕ), predicted vertical Poisson's ratio (vᵥ), and/or predicted horizontal Poisson's ratio (vₕ)) output by the probabilistic model.

The calibration component 108 may be configured to calibrate the probabilistic model. Calibration of the probabilistic model may include adjustment of the probabilistic model. The probabilistic model may be calibrated to increase the accuracy of derived physical quantities predicted by the probabilistic model. The probabilistic model may be calibrated to increase the accuracy of predicted physical attributes determined based on the derived physical quantities predicted by the probabilistic model. The probabilistic model may be calibrated to decrease/narrow the prediction intervals associated with the derived physical quantities predicted by the probabilistic model.

The probabilistic model may be calibrated based on the observed physical attributes of the subsurface region, and/or other information. The observed physical attributes of the subsurface region (from field measurement) may be compared with the predicted physical attributes of the subsurface region (determined from the predicted derived physical quantities output by the probabilistic model) to verify the accuracy of the predicted derived physical quantities output by the probabilistic model. Based on mismatch between the observed physical attributes of the subsurface region and the predicted physical attributes of the subsurface region, the probabilistic model may be adjusted to get to the correct value of predicted derived physical quantities and correct value of predicted physical attributes of the subsurface region. For example, physical attributes of the subsurface region may include stress. Stress in the subsurface region measured from field observation may be compared with predicted stress (determined based on derived physical quantities output by the probabilistic model). Based on mismatch between the observed stress and the predicted stress, the probabilistic model may be adjusted to output the value of derived physical quantities that will result in the predicted stress matching the observed stress. Calibration of the probabilistic model may be reperformed based on newly observed physical attributes of the subsurface region (newly collected field measurement data) to increase the accuracy of the probabilistic model and/or to decrease/narrow the prediction intervals of the probabilistic model.

In some implementations, the probabilistic model may be calibrated using a dominant factor analysis. The dominant factor analysis may be used to determine input to probabilistic model that has more impact on the output than other input. For example, input that has greater impact on decreasing confidence interval for model calibration may be identified using dominant factor analysis. Field observation may be guided based on dominant factor analysis to focus on collecting data that has greater impact on reducing uncertainty of the probabilistic model.

In some implementations, the probabilistic model may be calibrated using a Bayesian framework. Bayesian framework may utilize Bayesian inference to update prior beliefs (represented as probability distributions) based on new data (e.g., field measurement data). Calibration of the probabilistic model using the Bayesian framework may include updating prior belief of the base physical quantities and the derived physical quantities for the subsurface region using the observed physical attributes of the subsurface region based on a posterior analysis in the Bayesian framework. Within the Bayesian framework (Bayesian calibration framework), original observations of the base physical quantities (X) and the derived physical quantities (Y) may be treated as prior, and updated observations of the base physical quantities (updated X) and the derived physical quantities (updated Y) may be treated as posterior. The probabilistic model, along with the Bayesian framework, may be used to refine the prior belief over the base physical quantities and the derived physical quantities of the subsurface region. Calibration of the probabilistic model using the Bayesian framework may include updating functions modeled by the probabilistic model to capture the nonlinear relationships between the base physical quantities and the derived physical quantities of the subsurface region. The functions modeled by the probabilistic model may be updated (e.g., changed, refined) to model more accurately the nonlinear relationships between the base physical quantities and the derived physical quantities of the subsurface region.

In some implementations, the subsurface region may include one or more wellbores, and the probabilistic model along with the Bayesian framework may provide a probabilistic-driven stability analysis of the wellbore(s). Rather than simply providing qualitative evaluation of wellbores, the probabilistic model may provide uncertainty analysis of the stability of the wellbore. The quality of uncertainty analysis provided by the probabilistic model (through point estimation along with prediction interval) may increase as the probabilistic model is continually calibrated using new field measurement data.

In some implementations, the probabilistic-driven stability analysis of the wellbore may include analysis of sanding risk. Sanding risk may refer to likelihood of sand production in well/wellbore. Rather than simply providing whether sanding will or will not occur given particular wellbore operation parameters, the probabilistic-driven stability analysis of the wellbore may predict whether or not sanding will occur at a wellbore, along with prediction interval for the prediction. For example, completion selection process may include weighting risks of different completion options. One of the risk may be sand production. Different risk may be given a percentage and the risk of sanding may have a probability. Based on the risk level, one or more of the following options may be chosen: (i) installation of sand control completion, (ii) installation of surface equipment to monitor the sand, and/or other options.

In some implementations, the probabilistic-driven stability analysis of the wellbore may be used to evaluate risk factors for wellbore operations, such as for drilling of a wellbore, completion of a wellbore, production using a wellbore, and/or other wellbore operations. The probabilistic-driven stability analysis of the wellbore may enable a risk-based decision making process. For example, for drilling of a wellbore, engineer(s) may use the safe drilling window to determine the casing set point and/or the mud weight used for drilling. A probabilistic safe drilling window may be be combined with other factors to better determine the casing point and/or mud weight. It may reduce drilling non-productive time, reduce the risk of stuck pipe, and/or provide other benefits. For completion of a wellbore, risk of sand production may be taken into account and the probability of sanding may be used to facilitate completion of the wellbore by implementing one or more options based on the risk level. For production using a wellbore, risk of sanding may be taken into account for setting the choke sizes and therefore drawdown pressure and for determining surface sand handling equipment, such as desander, and/or other equipment. A probabilistic sand production risk may help production and facilitate engineers to properly design facilities and control production conditions. Such information may be used for injection (e.g., water/steam injection) and subsurface integrity assessment to ensure injected fluid (e.g., water/steam injection) does not go out of the target zone(s).

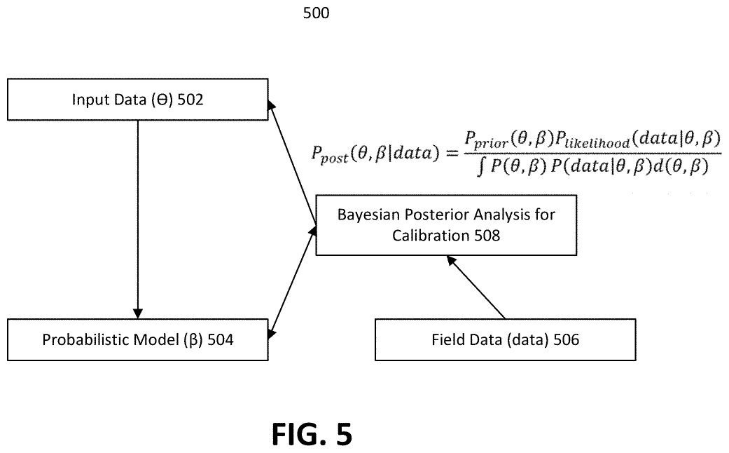

FIG. 5 illustrates an example workflow 500 for calibrating a probabilistic model using Bayesian framework. In the workflow 500, input data (Θ) 502 (e.g., wellbore data/physical quantities data, such as collected and/or determined from geotechnical core tests) may be used to train a probabilistic model (β) 504. The probabilistic model (β) 504 may be trained to fit the input data (Θ) 502, enabling prediction with uncertainty estimation. Beta (β) may refer to the parameter set of the probabilistic model.

The probabilistic model (β) 504 may capture nonlinear relationship among the input data (Θ) 502. Bayesian poster analysis for calibration 508 of the probabilistic model (β) 504 may be performed using field data (data) 506. The field data (data) 506 may be used to verify the outputs of the probabilistic model (β) 504 and adjust the probabilistic model (β) 504. Within the Bayesian framework, original observations of the input data (Θ) 502 may be treated as prior and updated belief on the input data (Θ) 502 may be treated as posterior. Within the Bayesian framework, original probabilistic model/parameter set (β) may be treated as prior and updated probabilistic model/parameter set (β) may be treated as posterior.

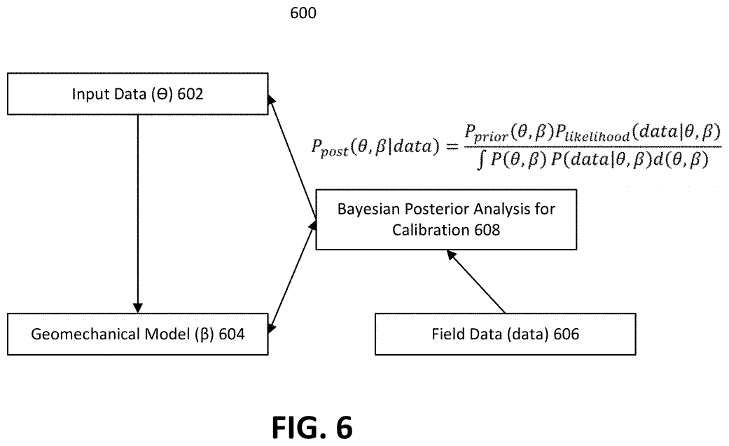

In some implementations, the Bayesian framework may be used to calibrate a geomechanical model for a subsurface region. A geomechanical model may simulate mechanics of rocks within the subsurface region. For example, a geomechanical model may simulate mechanics of rocks around a wellbore and may be used to calculate wellbore stabilities. FIG. 6 illustrates an example workflow 600 for calibrating a geomechanical model using Bayesian framework. In the workflow 600, input data (Θ) 602 (e.g., wellbore data/physical quantities data, such as collected and/or determined from geotechnical core tests) may be used to train a geomechanical model (β) 604. Bayesian poster analysis for calibration 608 of the geomechanical model (β) 604 may be performed using field data (data) 606 to calibrate both input assumption and model setting. Within the Bayesian framework, original observations of the input data (Θ) 602 may be treated as prior and updated belief on the input data (Θ) 602 may be treated as posterior. Within the Bayesian framework, original geomechanical model (β) may be treated as prior and updated geomechanical model (β) may be treated as posterior.

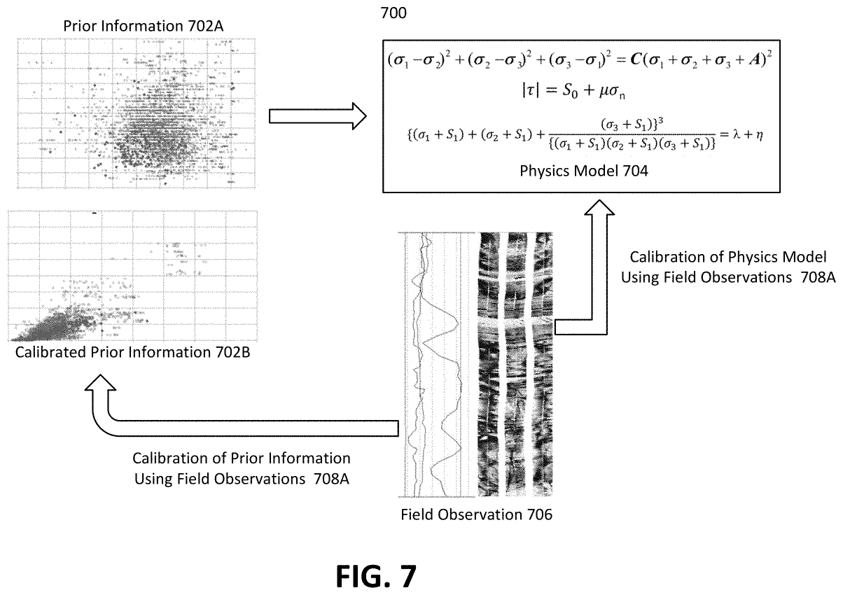

In some implementations, the Bayesian framework may be used to calibrate a physics model for a subsurface region. A physics model may simulate physics of rocks within the subsurface region. For example, a physics model may simulate physics of rocks around a wellbore and may be used to determine failure criteria. FIG. 7 illustrates an example workflow 700 for calibrating a physics model using Bayesian framework. In the workflow 700, prior information 702A (e.g., X, Y) may be used to train a physics model 704. The physics model 704 (e.g., based on first principle physics) may determine when failure is predicted for a wellbore for different physical quantities. For example, equation(s) that predict failure for a wellbore make take as input derived physical quantities (Y). Field observation 706 may indicate where and/or when wellbores failed (e.g., when failure criteria were met). The field observation 706 may be used to calibrate the physics model 704 (calibration of physics model using field observations 708A). The physics model 704 may be calibrated to provide more accurate prediction. The field observation 706 may also be used to calibrate the prior information 702A (calibration of prior information using field observations 708B). Prior belief on the prior information may be updated to provide more accurate belief of the prior information (calibrated prior information 702B).

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer-readable storage medium may include read-only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

In some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11 and the electronic storage 13 are shown to be connected to the interface 12 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 13. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11 is shown in FIG. 1 as a single entity, this is for illustrative purposes only. In some implementations, the processor 11 may comprise a plurality of processing units. These processing units may be physically located within the same device, or the processor 11 may represent processing functionality of a plurality of devices operating in coordination. The processor 11 may be separate from and/or be part of one or more components of the system 10. The processor 11 may be configured to execute one or more components by software; hardware; firmware; some combination of software, hardware, and/or firmware; and/or other mechanisms for configuring processing capabilities on the processor 11.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

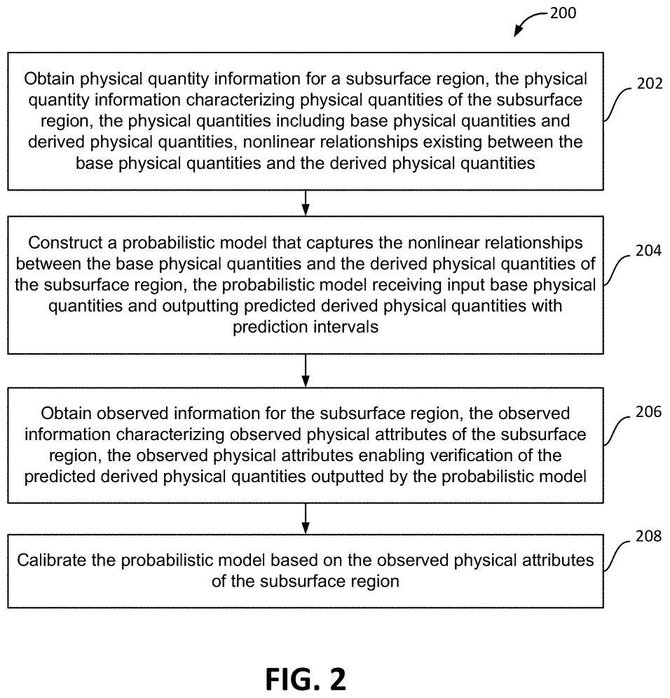

FIG. 2 illustrates method 200 for supporting geomechanical simulation of subsurface regions with uncertainty estimation. The operations of method 200 presented below are intended to be illustrative. In some implementations, method 200 may be accomplished with one or more additional operations not described, and/or without one or more of the operations discussed. In some implementations, two or more of the operations may occur simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 200 in response to instructions stored electronically on one or more electronic storage media. The one or more processing devices may include one or more devices configured through hardware, firmware, and/or software to be specifically designed for execution of one or more of the operations of method 200.

Referring to FIG. 2 and method 200, at operation 202, physical quantity information for a subsurface region may be obtained. The physical quantity information may characterize physical quantities of the subsurface region. The physical quantities may include base physical quantities and derived physical quantities. Nonlinear relationships may exist between the base physical quantities and the derived physical quantities. In some implementation, operation 202 may be performed by a processor component the same as or similar to the physical quantity information component 102 (Shown in FIG. 1 and described herein).

At operation 204, a probabilistic model that captures the nonlinear relationships between the base physical quantities and the derived physical quantities of the subsurface region may be constructed. The probabilistic model may receive input base physical quantities and output predicted derived physical quantities with prediction intervals. In some implementation, operation 204 may be performed by a processor component the same as or similar to the probabilistic model component 104 (Shown in FIG. 1 and described herein).

At operation 206, observed information for the subsurface region may be obtained. The observed information may characterize observed physical attributes of the subsurface region. The observed physical attributes may enable verification of the predicted derived physical quantities outputted by the probabilistic model. In some implementation, operation 206 may be performed by a processor component the same as or similar to the observed information component 106 (Shown in FIG. 1 and described herein).

At operation 208, the probabilistic model may be calibrated based on the observed physical attributes of the subsurface region and/or other information. In some implementation, operation 208 may be performed by a processor component the same as or similar to the calibration component 108 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system that supports geomechanical simulation of subface regions with uncertainty estimation, the system comprising:
one or more physical processors configured by machine-readable instructions to:
obtain physical quantity information for a subsurface region, the physical quantity information characterizing physical quantities of the subsurface region, the physical quantities including base physical quantities and derived physical quantities, nonlinear relationships existing between the base physical quantities and the derived physical quantities;
construct a probabilistic model that captures the nonlinear relationships between the base physical quantities and the derived physical quantities of the subsurface region, the probabilistic model receiving input base physical quantities and outputting predicted derived physical quantities with prediction intervals;
obtain observed information for the subsurface region, the observed information characterizing observed physical attributes of the subsurface region, the observed physical attributes enabling verification of the predicted derived physical quantities outputted by the probabilistic model; and
calibrate the probabilistic model based on the observed physical attributes of the subsurface region.

2. The system of claim 1, wherein predicted physical attributes of the subsurface region are determined based on the predicted derived physical quantities.

3. The system of claim 1, wherein the probabilistic model is calibrated using a Bayesian framework.

4. The system of claim 3, wherein calibration of the probabilistic model using the Bayesian framework includes updating prior belief of the base physical quantities and the derived physical quantities for the subsurface region using the observed physical attributes of the subsurface region based on a posterior analysis in the Bayesian framework.

5. The system of claim 4, wherein the probabilistic model along with the Bayesian framework are used to refine the prior belief over the base physical quantities and the derived physical quantities of the subsurface region.

6. The system of claim 3, wherein calibration of the probabilistic model using the Bayesian framework includes updating functions modeled by the probabilistic model to capture the nonlinear relationships between the base physical quantities and the derived physical quantities of the subsurface region.

7. The system of claim 3, wherein the subsurface region includes a wellbore, and the probabilistic model along with the Bayesian framework provides a probabilistic-driven stability analysis of the wellbore.

8. The system of claim 7, wherein the probabilistic-driven stability analysis of the wellbore includes analysis of sanding risk.

9. The system of claim 7, wherein the probabilistic-driven stability analysis of the wellbore is used for drilling of the wellbore, completion of the wellbore, or production using the wellbore, and enables a risk-based decision making process.

10. The system of claim 3, wherein the Bayesian framework is used to calibrate a geomechanical model for the subsurface region.

11. A method for supporting geomechanical simulation of subface regions with uncertainty estimation, the method comprising:
obtaining physical quantity information for a subsurface region, the physical quantity information characterizing physical quantities of the subsurface region, the physical quantities including base physical quantities and derived physical quantities, nonlinear relationships existing between the base physical quantities and the derived physical quantities;
constructing a probabilistic model that captures the nonlinear relationships between the base physical quantities and the derived physical quantities of the subsurface region, the probabilistic model receiving input base physical quantities and outputting predicted derived physical quantities with prediction intervals;
obtaining observed information for the subsurface region, the observed information characterizing observed physical attributes of the subsurface region, the observed physical attributes enabling verification of the predicted derived physical quantities outputted by the probabilistic model; and
calibrating the probabilistic model based on the observed physical attributes of the subsurface region.

12. The method of claim 11, wherein predicted physical attributes of the subsurface region are determined based on the predicted derived physical quantities.

13. The method of claim 11, wherein the probabilistic model is calibrated using a Bayesian framework.

14. The method of claim 13, wherein calibration of the probabilistic model using the Bayesian framework includes updating prior belief of the base physical quantities and the derived physical quantities for the subsurface region using the observed physical attributes of the subsurface region based on a posterior analysis in the Bayesian framework.

15. The method of claim 14, wherein the probabilistic model along with the Bayesian framework are used to refine the prior belief over the base physical quantities and the derived physical quantities of the subsurface region.

16. The method of claim 13, wherein calibration of the probabilistic model using the Bayesian framework includes updating functions modeled by the probabilistic model to capture the nonlinear relationships between the base physical quantities and the derived physical quantities of the subsurface region.

17. The method of claim 13, wherein the subsurface region includes a wellbore, and the probabilistic model along with the Bayesian framework provides a probabilistic-driven stability analysis of the wellbore.

18. The method of claim 17, wherein the probabilistic-driven stability analysis of the wellbore includes analysis of sanding risk.

19. The method of claim 17, wherein the probabilistic-driven stability analysis of the wellbore is used for drilling of the wellbore, completion of the wellbore, or production using the wellbore, and enables a risk-based decision making process.

20. The method of claim 13, wherein the Bayesian framework is used to calibrate a geomechanical model for the subsurface region.
